(19) United States
(12) Patent Application Publication
(10) Pub. No.: US 2009/0068757 A1
(43) Pub. Date: Mar. 12, 2009

(54) APPARATUS, PROCESS AND KIT FOR DETECTING ANALYTES IN A SAMPLE

(76) Inventors: Werner Lehmann, Lipten (DE); Uwe Schedler, Berlin (DE)

Correspondence Address: Nixon Peabody LLP, 200 Page Mill Road, Suite 200, Palo Alto, CA, 94306, US

(21) Appl. No.: 12/279,722

(22) PCT Filed: Feb. 16, 2007
(86) PCT No.: PCT/EP2007/051514

§ 371 Date: Oct. 16, 2008

(30) Foreign Application Priority Data
Feb. 17, 2006 (DE) 10 2006 008 323.7
Jun. 15, 2006 (DE) 10 2006 029 032.1

(51) Int. Cl. G01N 21/64; B01J 19/00; G01N 27/00; G01J 3/28; G01N 23/04; G01N 21/21; B05D 1/32; G01N 21/00

(52) U.S. Cl. 436/172; 422/68.1; 422/82.01; 422/82.02; 422/82.05; 422/82.08; 427/282; 436/164; 356/300; 356/364; 250/307

(57) ABSTRACT

The invention relates to an apparatus (100) for detecting analytes (26) in a sample comprising—a base carrier (10); —a multitude of sensor carriers (18) which are arranged on the base carrier (10) and can be assigned to at least two different sensor carrier populations (181, 182, 183); —the sensor carrier populations (181, 182, 183) being defined at least by different sensor molecules (24) which are assigned to the sensor carrier (18) and each have at least one measurable specificity for an analyte (26) or an analyte group, such that the population (181, 182, 183) of the sensor carriers (18) constitutes a coding which enables the assignment of sensor molecules (24) and/or analyte (26). The apparatus is characterized in that the sensor carriers (18) are present without contact to one another with a predetermined mean distance between one another and with a random statistical distribution on the base carrier (10) with regard to the population (181, 182, 183), as a result of which the detection of only a single entity of a sensor carrier (18) in each case is ensured during the analysis of the sensor molecules and/or of the binding analytes.

The present invention relates to an efficient device, an inexpensive method and a test kit for detection of analytes in a sample as well as a method for manufacturing the device.

Numerous methods for detecting analytes are known in the prior art. In the field of biological or clinical research and diagnostics, the analytes to be analyzed may include, for example, proteins, peptides, nucleic acids, sequence segments, carbohydrates, lipids and/or antigenic structures.

The relevancy of a parameter test may be expanded and improved by parallel detection of a larger volume of data from a single specimen—so-called multi-parameter analysis or multi-ligand analysis. Parallel detection also requires, for example, miniaturization by means of which the number of detectable parameters and ligands can be increased significantly. Miniaturized DNA technology makes it possible to analyze more than 10⁶ parameters per cm², so that a degree of miniaturization of less than 10 μm²/parameter is achieved on a chip. The two-dimensional positioning of sensor molecules interacting with ligands on a chip, e.g., through electrolithography or other methods such as piezoelectric printing technology, requires that the positioning method on the substrate material must be repeated for each test kit for all sensor molecules in the same way to ensure their regular arrangement—the so-called array—on the carrier.

The complex procedures necessitated for microlithography are suitable only for specific areas of application, however, which require very high parameter numbers and/or parameter densities such as pharmacogenetic tests.

Therefore, microparticles have also been described as a DNA array as an alternative to the aforementioned methods in the prior art. Such a microparticle array is based on the fact that several suspensions of different microparticle populations having different discrete fluorescence labelings are each conjugated with specific acceptor molecules (sensor molecules) (Lackner et al., 1999, Medgen 11, 16-17). After conjugation with the sensor molecules, the individual suspensions of the different microparticle populations are mixed and an aliquot of the mixture is added to the sample solution, so that particles of each suspension are present in mixture in the reaction batch. The ligands to be detected from the sample solution then bind to the corresponding sensor molecules in a ligand-specific manner and thus always only to discrete microparticles of a certain population.

Simultaneously or subsequently, a receptor fluorescent dye is bound to the ligands, such that the emission wavelength differs sufficiently from the emission wavelength of the fluorescent dye for labeling the microparticles. The fluorescence for identification of the microparticles, as well as the reporter fluorescence of the ligands bound to the particles, is then analyzed in the flow-through cytometer.

Microparticles which contain combinations of fluorescent dyes and can be used for various detection methods are known from the patents U.S. Pat. No. 5,326,692 and U.S. Pat. No. 5,073,498. A combination of fluorescent dyes allows a targeted influence on the excitation wavelength and the emission wavelength through the energy transfer between different polymerized dyes polymerized into them. In addition, it is possible by combining different fluorescent dyes to define microparticle populations in a more targeted manner in a flow-through cytometer.

However, a relatively large number of microparticles are needed per sample, i.e., approx. 5,000-10,000 per accepter for the flow-through cytometric measurement method (Smith et al., 1998, Clin Chem 44, 2054-2056) to be able to detect sufficient microparticles of a population in the measurement volume. Therefore, this causes an increase in the cost of materials, which is a disadvantage especially with expensive sensor molecule substances that are difficult to synthesize biochemically.

In addition, the relatively low resolution of particle populations with the help of the flow-through cytometer is a disadvantage. According to Carson et al. (1999, J. Immunol Methods 227, 41-52), only individualization of 64 particle populations by means of two fluorescent dyes is possible. Oliver et al. (1998, Clin Chem 44, 2057-2060) also describe the fact that relatively long measurement times of approximately 30 minutes up to 1 hour per sample are necessary to effectively detect several parameters specifically in parallel. The long measurement times sometimes result in a deleterious modification of the ligands and fluorescent dyes.

In the document WO 02/35228, fluorescence-coded microparticles loaded with sensor molecules as sensor carriers are described, leading to savings of material and the possibility of repeated measurement of one and the same microparticle. By using reference fluorescence and coding fluorescence on the part of the microparticles, the accuracy required for routine operation is achieved.

The random distribution of fluorescence-coded microparticles in the reaction vessel, however, necessitates a complex microscopic analysis method because the microparticles form clusters on the bottom of the vessel in the process of immobilization or they are randomly immobilized in a tight spatial distance when in very close proximity to one another. This disadvantage is manifested in particular when as many particles as possible are used during a combination of many parameters, which necessarily increases the particle density.

Particle arrays are produced by mixing various particle stock solutions with a defined specificity. Of this mixture, aliquots are used as a sample, which results in only a random number of particles of each suspension being added to the sample. To be sure that in fact a sufficient number of microparticles have entered the sample from each microparticle suspension, aliquots of the mixture containing approximately 50 microparticles of each suspension with a corresponding specificity must be taken. Thus, there are limits to any further savings of material.

The random distribution of microparticles in the array leads to microparticles being in close proximity in the array, which can be detected with microscopic methods, as described above. Other methods which have a lower resolution in control of areas of the samples cannot be used. For example, this applies to analysis of the microparticle arrays by mass spectrometry using MALDI.

The object of the present invention is therefore to make available a device, an efficient method and a test kit which will allow a higher sensitivity with a short measurement time while being inexpensive and being usable in routine operation. In particular, several measurement methods for determination of a plurality of properties of the analyte and/or the sensor molecule are to be usable individually and in combination with one another.

This object is achieved by a device for detecting analytes in a sample having the features of Claim 1. The inventive device initially comprises
a base carrier,
a plurality of sensor carriers arranged on the base carrier, assignable to at least two different sensor carrier populations,
where the sensor carrier populations are defined at least by different sensor molecules assigned to the sensor carrier, each having at least one measurable specificity for an analyte or an analyte group, so that the population of sensor carriers represents a coding that allows an assignment of sensor molecules and/or analyte.
According to the invention, the sensor carriers are contactless with respect to one another with a predetermined average distance from one another and with a random distribution on the base carrier with regard to the population.

Within the context of the present invention, the term “contactless” is understood to refer to an arrangement in which essentially all the sensor carrier individuals are arranged separately, where they maintain an average distance from the respective neighboring sensor carriers. Since the arrangement of a sensor carrier in a certain position on the base carrier is subject to a certain manufacturing-related inaccuracy, the distances among the sensor carriers show a certain scattering, so that the required distance is referred to here as the average distance. Furthermore, within the scope of the present invention, the term “random distribution” is understood to refer to an assignment of the individuals of a sensor carrier population to a certain base carrier position; it is not exactly predictable but instead is subject to the laws of statistics. It is thus impossible to predict whether an individual of one sensor carrier population or the other will be in a certain base carrier position.

Furthermore, in the sense of the present invention, an analyte is understood to refer to chemical and/or biological structures, whereby biological structures include all molecules formed, consumed or emitted by organisms. Chemical structures are understood to include all compounds capable of interacting with other molecules in such a way that it is possible to detect them. A sample or specimen in the sense of the present invention is thus material or a part and/or a small quantity of a material taken by a sampling device in the sense of the present invention, its properties to be tested physically, chemically and/or biologically. Biological specimens include, for example, a portion or a small amount of serum, blood, urine, respiratory air, lacrimal fluid or the like. However, specimens or samples according to the present invention also include partial amounts of wastewater, industrial process residues, marsh water or other environmental fluids that have been sampled.

Through the contactless arrangement of the sensor carriers while maintaining a minimum distance between the sensor carriers, this achieves the result according to the present invention that only a single sensor carrier is detected and characterized in each measurement point of a locally resolved measurement. On the other hand, with the cluster forming that is performed in the prior art with the sensor carriers, the problem is that several individuals are often detected by sensor carriers and their sensor molecules and the analytes interacting with them, which may lead to mixed results that are not usable. Accordingly, it is to be provided especially preferably that the predetermined distance between two neighboring sensor carriers is to be determined in advance as a function of the resolution of a measurement device used during detection of the analyte, in particular as a function of the weakest resolution and/or local accuracy of the measurement devices provided. For example, if a MALDI mass spectroscopy is one of the methods provided and if the laser ionization that takes place there is possible with a position accuracy of 500 μm on the base carrier and if it has at the same time the lowest resolution of all the measurement methods used, then it determines the predetermined spacing of the sensor carriers. The distance is determined here so that only one individual is always detected in MALDI laser excitation. The predetermined average distance of the sensor carriers is typically 1 to 1000 μm, 10 to 500 μm, preferably 20 to 100 μm.

According to a preferred embodiment of the invention, the sensor carrier is in a two-dimensional grid on the base carrier. Such an arrangement is relatively easy to implement in production. A single-layer arrangement also has the advantage that each position on the base carrier can be assigned accurately by XY coordinates and thus can be controlled in a targeted manner with the corresponding computer-controlled XY tables used with many types of equipment which are customarily used with microscopes, for example. Typical two-dimensional grid-type arrangements are tetragonal or trigonal structures, for example.

The inventive contactless arrangement of the sensor carriers on the base carrier may be implemented to advantage in two alternative ways. First, a base carrier with a suitable surface structure may be used (and/or a planar base carrier may be structured by a suitable method), whereby the sensor carriers are arranged in cavities in the structure. Alternatively, a base carrier with a planar surface may be used, whereby the inventive arrangement of sensor carriers is achieved by using a suitable shadow mask. The two variants are explained in greater detail in the exemplary embodiments. The base carrier may also structured in such a way that it functions as a shadow mask at the same time.

According to another preferred embodiment of the invention, in addition to the specific sensor module, the populations of the sensor carriers are also defined by at least one additional chemical and/or physical property of the sensor carrier which can be differentiated by at least one subsequent analytical method. For example, this may involve differentiable optical properties, in particular fluorescence properties, infrared and/or UV-VIS spectral properties, which are detectable with the corresponding spectrometers; different molecular weights of either the sensor carrier itself or a marker assigned thereto, detectable with mass spectrometric methods; electric properties, in particular conductivity and/or resistance; chemical reactivity; hydrophobicity; polarity; magnetic properties; NMR spectral properties; size; shape and/or material composition, but some of these properties can be linked together. For example, the material composition may be defined in particular by amounts of different pigments (e.g., fluorescent pigments), ions, doping with material of different molecular weights (e.g., different peptides or peptide lengths), so that the optical properties, the polarities and/or the molecular weights are influenced. The doping may be bound in the sensor carrier or to its surface and may also be used to bind the analytes from the sample, e.g., in the case of peptides. Several differentiable properties are implemented in an especially advantageous manner for coding a sensor carrier population to thus enable decoding with different analytical methods. In particular, a coding combination of the sensor carrier populations from different fluorescence labeling and different molecular weights is especially preferred.

Practically any materials, objects and structural designs may be considered as the base carrier, where the choice of the base carrier depends mainly on the analytical methods used and the sensor carriers to be immobilized. For example, from a structural regard the base carrier may be planar, macrostructured, microstructured or nanostructured, porous or not porous, visually transparent or not transparent, conducting, semiconducting or nonconducting; functionalized or not functionalized or may have several of these properties in combination. From a material standpoint, the base carrier may be made of one material or a combination of materials, including glass, mica, metals, semiconductor metals, (specifically silicon or germanium), organic or inorganic polymers (especially polypropylene, nitrocellulose or polyvinylidene fluoride). Suitable objects for base carriers include for example microtest plates (especially microtiter plates), glass or mica plates, semiconductor wafers, flexible membranes, braids or fibrils.

Likewise, there are hardly any limits to the material and structural embodiment of the sensor carriers within the scope of the present invention as long as the contactless arrangement on the base carrier is ensured. Thus the sensor carriers may be in the form of solid particles, in particular macroparticles, microparticles and/or nanoparticles, but microparticles are the most suitable of these microparticles for the typical analytical methods. However other consistencies and/or designs may also be used, e.g., highly viscous or hard nonspherical compositions, in particular hydrogels which have the corresponding sensor molecules and may optionally have the above-mentioned coding doping with fluorescent dyes, for example. From a material standpoint, the sensor carriers may have a polymer material in one or more layers, including in particular polystyrene, polymethacrylates, polypropylene, polyethylene, copolymers, silica or mixtures or composites thereof. It is advantageously possible for the polymer material to include or incorporate at least one additional material for coding, e.g., magnetic particles and/or fluorescent dyes. Furthermore, the polymer material of the sensor carriers may also have a surface functionality which serves in particular to provide for covalent or non-covalent coupling of the sensor molecules. A typical surface functionality comprises, e.g., functional chemical groups in particular carboxyl, amino, aldehyde and/or epoxide groups and/or oligonucleotides, aptamers, peptides, lectins, antibodies, antigens, carbohydrates or small organic compounds such as biotin or avidin.

The sensor molecules need not necessarily be covalently bonded or non-covalently bonded to the exterior surface of the sensor carriers; instead they may also be secured on the interior surface, e.g., of pores. The sensor molecules are selected in particular from the group comprising haptenes, antigens, proteins, peptides, amino acids, antibodies, small organic molecules, nucleic acids, carbohydrates, lipids and/or parts of mixtures of these molecules. The decisive factor is that they are suitable for specifically interacting with the analyte, e.g., in the form of antigen-antibody interactions or the like. Accordingly, the complementary analyte may originate from the same group.

The inventive device, in particular the inventive arrangement of the sensor carrier on the base carrier can be implemented with two fundamental manufacturing approaches—namely, a physical and a chemical approach—such that the physical approach comprises at least the following steps:
applying at least one shadow mask having a defined hole pattern to a base carrier or spatial structuring of the base carrier so that cavities are formed with a predetermined spacing on the base carrier, and
applying a mixture of a plurality of sensor carriers, each of which can be assigned to at least two different populations, to the base carrier, so that the sensor carriers are arranged in the cavities, a dimension of the cavities and the sensor carriers relative to one another being such that each cavity has room for at most one sensor carrier.

Against this background, the chemical manufacturing principle comprises at least the following steps:
chemical modification of the base carrier, so that chemical bonding areas are formed with a predetermined spacing on the base carrier, and
a mixture of a plurality of sensor carriers is applied to the base carrier, each being assignable to at least two different populations, so that the sensor carriers are arranged on the binding areas such that one dimension of the binding areas and the sensor carriers relative to one another is such that there is room on each binding area for at most one sensor carrier.

Thus according to the physical approach there is a three-dimensional spatial structuring in the form of cavities and according to the chemical approach there is a chemical structuring in the form of binding areas, but both approaches combine the principle whereby the dimension of the cavities and/or the binding areas allows only the arrangement of a single sensor carrier, respectively, so that the arrangement of sensor carriers spaced a distance apart is guaranteed.

The physical approach can thus be implemented according to two variants. According to the first variant, a shadow mask is used, either remaining permanently on the base carrier or optionally being removable after application of the sensor carriers and, if provided, after their immobilization on the base carrier. According to the second variant, structuring of a surface of the base carrier is performed and/or a base carrier that has already been structured is used. With both physical variants, cavities are created on the base carrier and are used to accommodate the sensor carriers. According to the chemical approach, the entire carrier can be chemically surface-modified, for example, and then a suitable (lithographic) mask can be placed on that and the areas not covered by the mask can then be altered by means of suitable radiation (e.g., UV), so that they lose their ability to bind the sensor carriers. Alternatively, the mask may be applied first and then the unmasked regions of the base carrier can be chemically modified so that they maintain the ability to bind the sensor carriers before the mask is removed again. In all the methods mentioned above, the deciding factor is the relative dimension of the cavities/binding areas and the sensor carriers relative to one another which ensures that at most one sensor carrier is provided per cavity/binding area. This allows the inventive contactless arrangement of the sensor carriers on the base carrier. The cavities/binding areas may have any desired shape in all cases, in particular a round or angular contour.

Another aspect of the invention relates to a method for detecting an analyte in a sample. In this method, the inventive device is brought into contact with the sample containing (potentially) at least one analyte, whereby the analyte interacts with corresponding sensor molecules on the sensor carrier and thus binds them covalently or non-covalently. Next, after one or more washing steps to remove unbound or excess sample constituents, if necessary, at least one property of the sensor carrier and/or of the analyte is detected simultaneously or in succession with position resolution. The inventive separate contactless arrangement here ensures that in the test(s) with position resolution, only one individual of the sensor carriers is always detected at each measurement point, so the method has a high measure of accuracy and reliability.

It is advantageously possible not only for the analyte to be identified but also for a complex analysis to be performed, also pertaining to, for example, a structural elucidation of the analyte and/or the sensor molecule or analyzing the binding behavior and other properties. This requires the use of multiple analytical methods, e.g., fluorescence spectroscopy, infrared spectroscopy, UV-VIS absorption spectroscopy, ellipsometry, mass spectroscopy, atomic force microscopy, scanning near-field microscopy, transmission electron microscopy or scanning electron microscopy or simultaneous or sequential combinations of various methods. The use of different methods, usually at separate points in time, the inventive arrangement of the sensor carriers on the base carrier is beneficial. It allows an unambiguous XY position determination and thus targeted control of a position determined once and assigned to a sensor molecule for subsequent measurements, although no specific coding marker is provided on the sensor carrier for a subsequent method. In addition, however, it is of course also possible within the scope of the invention to equip the sensor carriers with a plurality of population-specific markers, each of which is specific for one or more of the measurement and analysis methods provided, i.e., can be detected and differentiated with this method.

The present invention also relates to a kit for detecting at least one analyte in a sample, comprising the inventive device and its individual components as well as additional reagents. The individual components include in particular the base carrier, at least two populations of sensor carriers and sensor molecules, the latter in free form or already bound to the sensor carriers. The kit allows an especially simple, inexpensive and flexible means of performing the detection of analytes.

Other advantageous embodiments are the subject matter of the other dependent claims.

There follows a detailed description of the materials that can be used within the scope of the present invention, the preferred procedures for producing the device according to the invention and for detection and analysis of analytes.

Microparticles constitute an advantageous embodiment of the sensor carriers. Microparticles in the sense of the present invention are heterogeneous and/or homogeneous fractions of microscopic particles with a size of 1 to 500 μm, in particular 1 to 100 μm, preferably 10 to 50 μm. The microparticles here may contain organic and/or inorganic constituents. The microparticles may be polymers, for example, which are precipitated on the material to be enclosed, e.g., on a fluorescent dye, after emulsification or interfacial polymerization. The microparticles may comprise polystyrene and/or polyphosphoric acid, polyvinyl or polyacrylic acid copolymers. However, it is also possible to provide for the microparticles to comprise oxidic ceramic particles such as silicon dioxide, titanium dioxide or other metal oxides. The microparticles may also be nanoparticles, crystals or magnetites. However, crosslinked polypeptides, proteins, nucleic acids, macromolecules, lipids, e.g., as vesicles and the like also constitute microparticles within the context of the present invention. Production of microparticles is disclosed in the documents U.S. Pat. No. 6,022,564, U.S. Pat. No. 5,840,674, U.S. Pat. No. 5,788,991 and U.S. Pat. No. 5,7543,261 [sic], for example. Microparticles as sensor carriers also include microparticles having several layers, e.g., a stable polymer core surrounded by a hydrophilic matrix of hydrogel or polyethylene glycol, for example.

A sensor carrier population in the sense of the present invention is understood to refer to sensor carriers which do not differ at least with regard to the sensor molecules and thus their analyte specificity. In other words, sensor carriers of two sensor carrier populations differ at least in their analyte specificity. A preferred additional differentiating feature of sensor carrier populations is the labeling with the fluorescent dye or fluorescent dyes and/or another measurable property. For example, a sensor carrier population may comprise sensor carriers which differ in their fluorescence wavelength (e.g., due to fluorescent dyes that fluoresce in red, yellow and/or blue), in their intensity and/or in the fluorescence lifetime of the labeling fluorescent dyes. Within the context of the present invention it is also possible to advantage to code the sensor carrier population with two or more different fluorescent markers. A first fluorescence marker (coding fluorescence) is used here to identify the population and a second marker (reference fluorescence) is used to quantify the ratio of sensor carrier and/or sensor molecule(s) to bound analyte molecules. Such a procedure is described in WO 02/35228. However, a sensor carrier population may also be defined by the ratio of different fluorescent dyes. For example, all sensor carriers whose fluorescence labeling comprise green and red fluorescent dye in a 1:1 ratio may belong to one sensor carrier population, while a second population may have the same fluorescence markers but in a 1:0.5 ratio.

Fluorescent dyes, which are used to label the sensor carriers, are all substances that can send detectable luminescence signals (fluorescence and/or phosphorescence), i.e., after excitation they can emit the absorbed energy in the form of radiation of the same or longer wavelength. Organic or inorganic pigments capable of luminescence or so-called quantum dots may also be used for fluorescent dyes in the sense of the present invention. Fluorescent dyes, in particular for coding fluorescence and/or reference fluorescence (see above), e.g., dansyl chloride, fluorescein isothiocyanate, 7-chloro-4-nitrobenzoxadiazole, pyrenebutyryl acetic acid anhydride, N-iodoacetyl-N′-(5-sulfonic acid 1-naphthyl)-ethylenediamine, 1-anilinonaphthalene-8-sulfonate, 2-toluidinonaphthalene-6-sulfonate, 7-(p-methoxybenzylamino)4-nitro-benzo-2-oxa-1,3-diazole, formycin, 2-aminopurineribonucleoside, ethenoadenosine, benzoadenosine, α- and β-parinaric acid and/or Δ^{9,11,13,15}octaecatetraenoic acid, cadmium selenite crystals of one or various sizes and others. For example, transition metal complexes containing the following substances are used as fluorescent dyes, in particular also for reference fluorescence: ruthenium (II), rhenium (I) or osmium and iridium as the central atom and diimine ligands; phosphorescent porphyrins with platinum, palladium, lutetium or tin as the central atom; phosphorescent complexes of the rare earths such as europium, dysprosium or terbium; phosphorescent crystals such as ruby, Cr-YAG, alexandrite or phosphorescent mixed oxides such as magnesium fluorogermanate and/or cadmium selenite crystals, fluorescein, aminofluorescein, aminomethylcoumarin, rhodamine, rhodamine 6G, rhodamine B, tetramethylrhodamine, ethidium bromide and/or acridine orange.

In particular the following substances may be used as a combination of fluorescent dyes for coding and reference fluorescence:

ruthenium(II) (tris-4,7-diphenyl-1,10-phenanethroline)/HPTS,
ruthenium(II) (tris-4,7-diphenyl-1,10-phenanethroline)/fluorescein,
ruthenium(II) (tris-4,7-diphenyl-1,10-phenanethroline)/rhodamine B,
ruthenium(II) (tris-4,7-diphenyl-1,10-phenanethroline)/rhodamine B-octadecyl ester,
ruthenium(II) (tris-4,7-diphenyl-1,10-phenanethroline)/hexadecyl acridine orange,
europium(III) tris-theonyl-trifluoromethyl acetonate/hydroxy-methylcoumarin,
platinum(II) tetraphenylporphyrin/rhodamine B octadecyl ester,
platinum(II) tetraphenylporphyrin/rhodamine B,
platinum(II) tetraphenylporphyrin/naphthofluorescein,
platinum(II) tetraphenylporphyrin/sulforhodamine 101,
platinum(II) octaethylporphyrin/eosin,
platinum(II) octaethylporphyrin/thionine,
platinum(II) octaethylketoporphyrin/Nile blue,
Cr(III) YAG/Nile blue,

### Cr(III) YAG/naphthofluorescein,

aminocoumarin/aminofluorescein,
aminocoumarin/rhodamine 6G,
aminocoumarin/tetramethylrhodamine,
aminocoumarin/acridine orange,
aminofluorescein/rhodamine 6G,
aminofluorescein/tetramethylrhodamine and
aminofluorescein/ethidium bromide.

The fluorescent dyes may be polymerized, e.g., during the production of the sensor carriers (e.g., microparticles) or they may be co-immobilized subsequently on the sensor carriers. The fluorescent dyes may be introduced directly into a solvent for the sensor carriers, e.g., during production of the sensor carriers. By polymerizing the fluorescent dyes, it is possible to accurately determine the amount of fluorescent dyes bound to the sensor carriers. The fluorescent dyes may either be polymerized in such a way that they are largely inert or interact with the analyte. In addition, incorporation of the fluorescent dyes into a sol-gel glass as sensor carriers (microparticles) with subsequent boiling, pulverization and dispersion of the glass is possible. When using pulverized fluorescent dyes, the dye may be dispersed as a sensitive layer, e.g., in the form of the coating of the outside of the sensor carriers. This may be accomplished, for example, by covalent bonding or electrostatic binding of the fluorescent dyes to the surface of the sensor carrier. For example, hydroxyl groups, amphiphilic electrolytes, phospholipids and ionic components may be used to bind fluorescent dyes to the surface of the sensor carriers.

In addition to the fluorescence coding of the sensor carriers, non-fluorescent substances may also be used for coding the sensor carriers. Whereas the fluorescent coding can be detected very well by means of fluorescence spectroscopy or scanning near-field microscopy, peptides used for coding or small organic or inorganic molecules are preferably detected on the basis of their mass, e.g., by MALDI mass spectroscopy. Doping, e.g., by heavy metals can also be detected based on the molecular weight but also by atomic spectroscopy, e.g., EDAX with electron microscopic detection.

It is provided that the sensor carriers conjugate with or bind to sensor molecules. Therefore specific sensor molecules are coupled to each population of sensor carriers. The sensor molecules may be functional groups such as amino groups, carboxyl groups, thiol groups, hydroxyl groups or epitopes, paratopes, carbohydrates, lectins or oligonucleotide or polynucleotide sequences. Epitopes may be, for example, antigenic determinants which interact with the antigen binding part of an antibody or with a receptor. Paratopes in the sense of the invention may be, for example, the parts of an antibody that interact specifically with antigenic structures. The sensor molecules may bind covalently, non-covalently, by ionic bonding or other interactions to the respective sensor carrier population.

The sensor carrier populations are preferably immobilized on the base carrier. By means of this immobilization, the sensor carriers are put in a state that limits their reaction space. Immobilization in the sense of the present invention is understood to refer to all methods which lead to a restriction of the mobility of the microparticles by biological, chemical or physical methods. To do so, for example, the desired suspensions of sensor carrier populations are mixed and small aliquots of the mixture are pipetted onto the base carrier by means of a dispenser. The sensor carriers then sediment in droplets and contact the surface of the carrier, whereby 1 to 1,000,000, in particular 1 to 100,000, preferably 1 to 10,000 and especially preferably 1 to 1000 or fewer sensor carriers of a population, in particular microparticles, can be bound in random distribution to the base carrier. Drying of the droplet on the carrier should be prevented if the drying of the sensor molecules would have a negative effect on the desired binding of the analyte.

The immobilization of microparticles on a carrier may be performed directly or via spacers. Spacers in the sense of the present invention include all spacers which can develop a short carbon chain between the sensor carrier and the base carrier, for example. Hydroxylated chains, for example, may be used to prevent specific hydrophobic interactions. However, it is also possible to immobilize the sensor carriers via the sensor molecules. In binding the sensor carriers with the help of their own binding sites, it is possible to select the sensor molecules completely freely because they need not impart the binding to a possible base carrier. In immobilization of the sensor carriers with the help of the sensor molecules, it is provided that the sensor molecules will have the properties required for this such as molecular charge, chemically modifiable groups and/or immune affinities, nucleic acid affinities and/or hybridization affinities, etc. Due to the immobilization of the sensor carriers with the help of the sensor molecules, an immobilization with the help of the spacers need not necessarily be performed. It is of course also possible for the sensor carriers to be immobilized on the surface of the base carriers by means of binding sites on their surface. To accelerate the immobilization process or when using immobilization and mobilization cycles, preferably magnetic or paramagnetic particles are used in a continuous or oscillating magnetic field.

Through location-specific application of functionalities for addressed immobilization of sensor carriers, it is possible to apply a 2D array in the form of lines, boxes or dots to the base carrier. Functionalities may include capture molecules comprising oligonucleotides, aptamers, peptides, lectins, antibodies, antigens, carbohydrates and/or defined chemical groups or small organic compounds such as biotin or avidin.

As the base carrier, preferably in particular microtest plates, glass plates, silicon, semiconductors, flexible membranes, braids or fibrils, in particular of polypropylene and/or nitrocellulose, glass and/or polyvinylidene fluoride (PVDF) are preferably used. For example, microtiter plates may be used as the microtest plates. Microtest plates advantageously have dimensions which allow their use in numerous laboratory routines. For example, numerous fluorescence measurement devices, such as fluorescence microscopes are designed so that microtest plates may be used as the standard. Immobilization of the sensor carriers on special laboratory vessels, such as microtiter plates, petri dishes, multiple dishes, multi-dishes, pans and other culture vessels and microscope slides therefore advantageously also allow the use of existing laboratory facilities and equipment for incubation, freezing, lyophilization and the like in clinical laboratories or research laboratories. For example, microtiter plates with transparent nonfluorescent flat bottoms may be preferred for use as the microtest plates.

In the inventive method, masks or structured base carriers may be used so that the sedimenting sensor carriers/microparticles are deposited randomly or as individually as possible in a targeted manner in microcavities of the base carrier to thereby be immobilizable in a spatially separate manner from other sensor carriers of the same or different specificity. For manufacturing the masks, preferably injection molding methods, electrolithographic methods, etching techniques or weaving techniques are used. Mesh apertures from transmission electron microscopy or gauze of different pore and mesh web sizes may be used as the mask to advantage. The preferred mesh webs have a thickness of 1-200 μm and the hole diagonals/hole diameters amount to between 10 and 500 μm. If the particles have a diameter of 50 μm, the preferred hole radius is 70 μm and the web thickness is 50 μm. If the particles have a diameter of 10-15 μm, the preferred hole radius is 15-25 μm and the web thickness is 30-50 μm. Mesh apertures may be covered with Formvar, for example, whereby the Formvar film may simultaneously be used as the base carrier in a functionalized or unfunctionalized form. One or more masks may be attached or positioned permanently or temporarily on the base carrier.

The number of sensor carrier populations to be immobilized on the carrier is determined in particular by the number of sensor molecule specificities which are necessary for characterization of the analytes. The possible number of discrete populations, however, also depends on the available dyes and/or other molecules with discrete masses and techniques for labeling the sensor carriers as well as depending on the number of different colors and/or masses in the detection meter. For example, it is advantageously possible to produce approximately 60 to 100 different discrete sensor carrier populations with two colors/weights. The number of populations can be increased to approx. 500 to 1,000 additional readily differentiable sensor carrier populations by a more accurate determination of the fluorescence intensities/weight ratios and/or by another color.

According to the invention, at least one sensor carrier population is incubated with the sample to be analyzed. By incubation of a new line of the (immobilized) sensor carriers and the sample to be analyzed, it is possible that analytes from the sample might interact with sensor molecules bound to the sensor carriers. For example, if the sensor molecules are bound antibodies, then the analytes may bind to them in the form of antigenic structures. Since the sensor molecules are bound to the sensor carriers, this allows a binding of the analytes to the sensor carriers via the sensor molecules. During incubation of the sensor carriers with the sample to be analyzed, reaction conditions which allow an efficient interaction between the analytes and the sensor carrier population are preferably created.

Such reaction conditions may include for example an elevated temperature and convection (e.g., shaking or stirring).

It is advantageously possible to provide for the analytes to be labeled with at least one reporter fluorescence. It is of course possible to label the analytes before and/or after binding to the sensor molecules. Fluorescent molecules that may be used include, for example, fluorescein isothiocyanate, tetramethyl rhodamine isothiocyanate, Texas Red, 7-amino-4-methyl-coumarin-3-acetic acid, phycoerythrin and/or cyanines and others or antibody-conjugated fluorescence particles which bind to the analyte with the help of antibodies, for example. It is possible for example to label the analytes directly with a fluorescent dye. Through direct labeling of the analytes, it is possible to avoid the use of fluorescence-labeled antibodies or other marker-carrying structures. Direct labeling of the ligands may be accomplished in particular by fluorescent dyes which emit a fluorescent signal or which quench the fluorescence of other markers in a targeted manner. However, the analytes may also be enzyme-labeled. Examples of enzyme-labeled molecules include horseradish peroxidase, alkaline phosphatase and/or glucose oxidase. Gold particles are gold quantum dots may also be used for labeling the analytes. However, it is also possible to entirely omit labeling of the analytes.

Detection of the analyte(s) is advantageously performed by a comparison of the fluorescence(s) of the sensor carrier population with the reporter fluorescence and/or the molecular weights of the fluorescent dyes or other molecules with a defined mass. For example, the intensities of the fluorescences of the sensor carrier population and of the analyte(s) may be compared in a fluorescence spectrometric determination in such a way that the intensity of the analyte-carrying sensor carrier population as well as the number of bound analytes can be analyzed in particular. Thus, for example, statements may thus be made about which analytes are bound to certain discrete sensor carrier populations and how many.

It is also possible to analyze the structures of the analytes or analyte complexes by atomic force microscopy, scanning near-field microscopy as well as scanning microscopy and electron microscopy in addition to the molecular weight. The various techniques may also be used in succession. It is also possible to use semiconductor effects of the sensor carriers or base carriers or masks for electric detection or altered reflections.

It is also possible to provide for the parameters of the sensor carrier fluorescence not to be affected by the analytes in its parameters or for the various fluorescences to influence one another. According to the invention, it is also possible for the fluorescent dyes to be excited jointly and simultaneously by one source and detected jointly by one detector. It is also possible for the sensor carrier fluorescence to be used for excitation of the reporter fluorescence. The different fluorescent dyes may also be excited separately by different light sources such as lasers, dye lasers or LEDs.

It is provided according to the present invention that multiple analytes may be detected simultaneously by loading the analytes with individual sensor molecules via discrete sensor carrier populations. Parallel determination of multiple parameters by simultaneous detection of different analytes allows a characterization of multiple analytes with a small amount of material and without consuming much time.

However, it is also possible to provide for the analytes to be bound via a linker molecule. The linker molecule may be covalently or non-covalently bound to the analyte, for example. The linker molecule may modulate the mobility of the analyte so that the signal emitted by the analyte or by the fluorescent dye bound to the analyte can be detected efficiently.

In another embodiment variant of the invention, the analytes are labeled with a uniform fluorescent dye. With the uniform labeling of the analytes, the total number of labeled analytes bound to the sensor carrier can be determined to advantage. The analysis of the analytes may be performed, for example, by the assignment to discrete populations based on the labeling of the sensor carriers. It is preferable for the fluorescent dyes and/or enzymes to be present in monomer and/or polymer form. The fluorescent dyes may be inorganic compounds, for example, such as compounds of the rare earth metals or uranium compounds or organic compounds, for example. However, it is also possible, instead of labeling by fluorescent substrates, to use chromogenic substrates which are capable of chemiluminescence in particular. For sensitive detection of the analytes, fluorescent microparticles may also bind to the analytes.

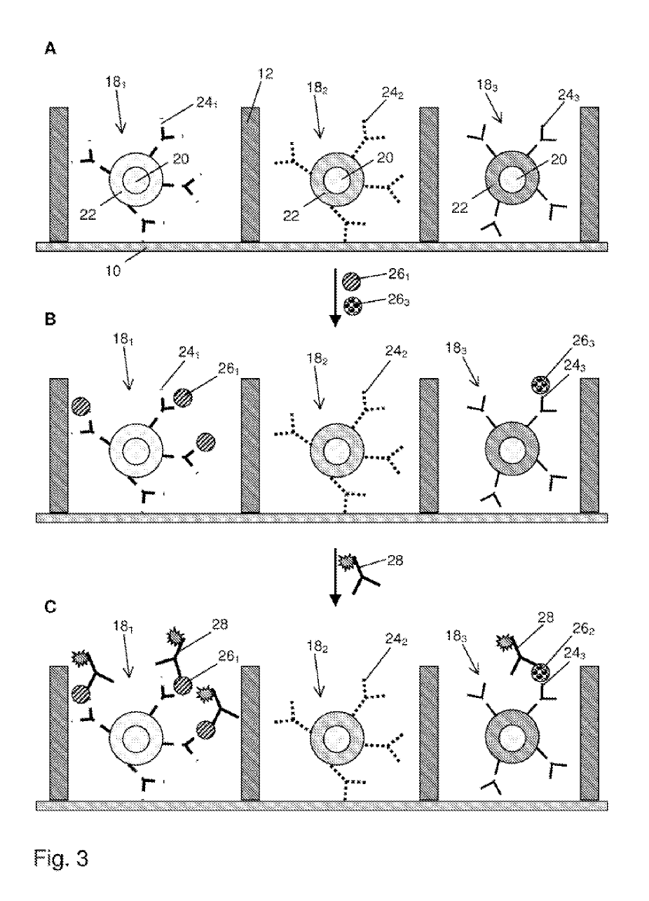

In an especially preferred embodiment of the invention, different antibodies may be detected in a serologic specimen (see FIG. 3). Fluorescent sensor carriers of different colors are each conjugated with different antigens as sensor molecules and are immobilized on a base carrier by means of the antigens. During the subsequent incubation, antibodies are advantageously bound as analytes from a patient's serum to the antigens for which they are specific. The bound antibodies are detected with the help of a secondary antibody which has a reporter fluorescence. For the analysis, the fluorescence of the sensor carriers and the reporter fluorescence are measured, in particular for each pixel of a microtiter plate cavity.

The invention also includes a test kit, where the test kit preferably includes at least two sensor carrier populations which can bind to specific sensor molecules. The sensor carriers that are preferably immobilized may advantageously include at least two fluorescent dyes which differ with regard to their spectral properties and/or their fluorescent lifetime. Despite the lower number of sensor carriers used, a measurement accuracy that meets the requirements of routine clinical use, for example, can be achieved with the test kit to advantage. In addition, the test kit may have a design such that the fluorescence is analyzed with fluorescence scanners and/or fluorescence microscopes, mass spectrometers, atomic force microscopes, scanning near-field microscopes and electron microscopes due to the immobilized sensor carriers, thus allowing a high measurement accuracy and a great depth of information over multiple detection parameters—for example, in comparison with flow-through cytometers. The test in the sense of the present invention may be designed in such a way that the sensor carrier and sensor molecule are solid or dissolved in different reaction vessels and the fluorescent dyes and reagents are also stored separately for the immobilization. For detection of an analyte, immobilization and fluorescence labeling of the sensor carrier populations and binding of the sensor molecules to the sensor carriers take place in such a way that the immobilized and fluorescence-labeled sensor carrier populations are present with the bound sensor molecules on the base carrier in a reaction vessel. Then the sample to be analyzed is added to this vessel. However, it is also possible to design the kit so that all the reagents that are needed for detection of the analyte are already present in one reaction vessel. With the inventive test kit, it is advantageously possible to analyze biological and/or chemical specimens. In biological specimens such as serum, molecular parameters may be detected for characterizing complex biomedical states such as the immune status or the genetic predisposition for certain diseases or detection and influencing of expression. By immobilization the sensor carrier population, it is possible within a very short period of time, for example, to characterize a specimen having only a small number of analytes to be analyzed or having competitive analytes. It is also possible to detect unknown analytes and analyte complexes and to analyze them structurally.

For determination of diagnostic serologic parameters, the invention also includes the use of fluorescence-labeled sensor carrier populations which are conjugated with specific sensor molecules, e.g., human or animal antibodies to infection pathogens, antigens, autoantigens and allergens, pharmacologically important binding sites in proteomas, genomes and other nucleic acids, e.g., hormone receptors, drug binding sites, peptide binding sites, carbohydrate binding sites and DNA binding sites and/or for performing expression analyses of important genes and their products such as tumor proteins, HLA antigens and for analysis of single nucleotide polymorphisms and mutations.

The advantages of the invention include, for example, the fact that a reduction in the number of sensor carriers is possible through the arrangement of sensor carrier populations in a grid. In comparison with flow-through cytometric methods, this advantageously leads to sparse use of the sensor molecules. Detection of the bound analytes via fluorescent microparticles, quantum dots or luminescent pigments, for example, leads to sensitivity into the individual molecular range. Due to the 3D structure of porous particles in particular, a high and constant sensor molecule density is achieved, which also contributes toward an increase in sensitivity and reproducibility, in particular in comparison with the use of planar, position-coded 2D arrays. According to the present invention, the number of sensor carriers, in particular microparticles, per sample and the duration of the measurement process can be reduced. By destroying the sensor carrier during a mass spectrometric analysis, the analytes which have been bound to the sensor molecules in the interior of the pore structure of the sensor carriers are also released, thereby increasing the sensitivity of the measurement process.

The use of predetermined grids makes the use of a reference fluorescence superfluous because the measurement fields in which only one sensor carrier/microparticle has been immobilized are particularly easy to discern, which is especially important to avoid superpositioning of signals and thus for automatic analysis.

Through immobilization of microparticles on standardized carriers such as microtiter plates or microscope slides, existing laboratory routines such as automatic ELISA analyzers can be utilized, for example.

The invention will be explained in greater detail below in exemplary embodiments on the basis of the figures, in which:

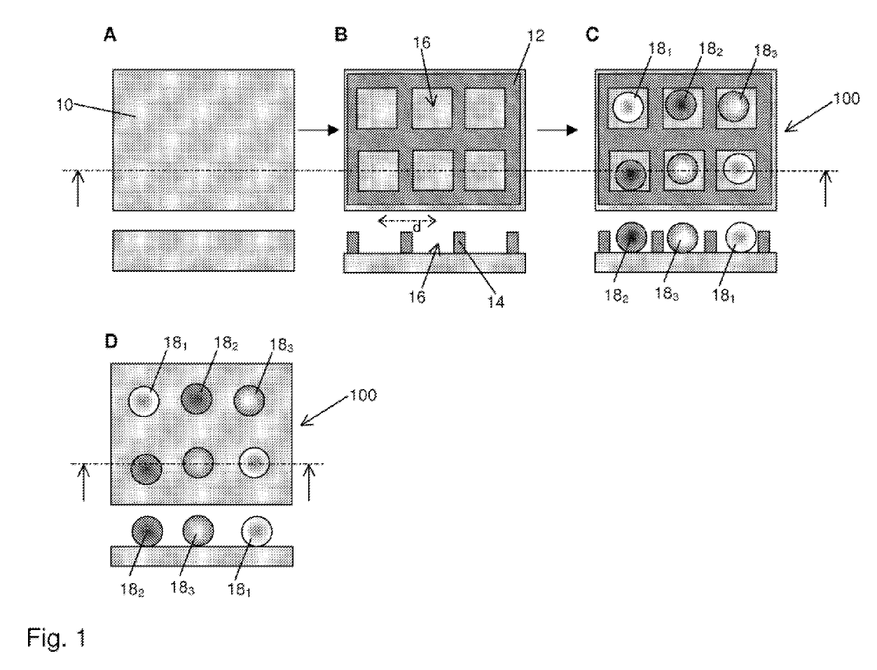

FIG. 1 shows process steps for producing a device for detecting an analyte according to a first inventive embodiment;

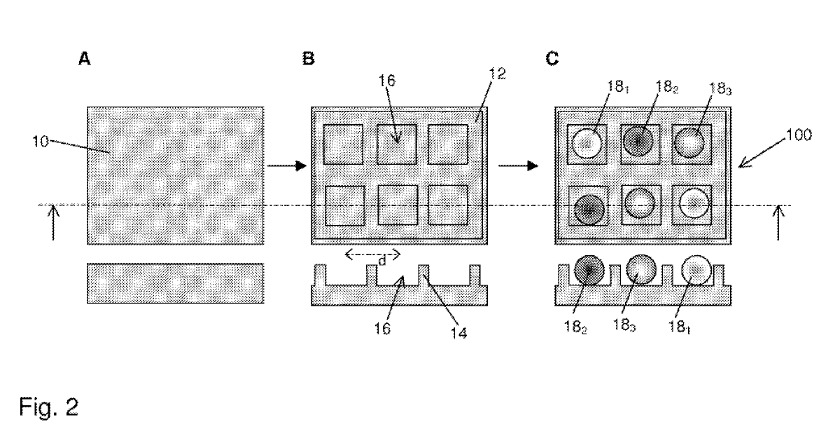

FIG. 2 shows process steps for producing a device for detecting an analyte according to a second inventive embodiment and

FIG. 3 shows process steps for detecting an analyte using a device according to FIG. 1.

FIG. 1 shows schematically and in greatly simplified form individual steps of a first inventive production variant for an inventive device using a perforated sheet. In the lower part of substeps A through D, sectional views according to the perspectives drawn in the upper part are shown.

A base carrier 10 which has a flat planar structure here and may be made of a metallic or polymeric material, for example, is used (FIG. 1A). A shadow mask 12 is placed on the base carrier 10 (FIG. 1B), having holes of a defined hole width (i.e., diameter) bordered by webs 14 and with a defined center-center distance. For reasons of simplicity, only six holes are shown here, although typical shadow masks such as those conventionally used for electron microscopy, for example, will have a much higher number of holes, typically several hundred holes or several thousand holes. In addition to the angular square shape illustrated here, the holes may also be round or may have other contours. Cavities 16 are formed by the holes in the shadow mask 12, these cavities being bordered at the sides by the webs 14 of the shadow mask 12 and at the bottom by the surface of the base carrier 10.

Then a mixture of different sensor carriers 18 is applied to the construct comprising of the base carrier 10 and the shadow mask 12 and distributed there (FIG. 1C). In the example shown here, the individuals of the sensor carriers 18 may be assigned three different sensor carrier populations 18₁, 18₂ and 18₃ which can be differentiated from one another at least by different sensor molecules (not shown here) and thus analyte specificities, preferably by additional properties such as different fluorescence labelings, different magnetic dopings, molecular weights and/or others. The sensor carriers 18 may be, for example, microparticles, in which case other shapes and consistencies may also be used to advantage within the scope of the present invention, e.g., suitably doped and/or functionalized hydrogels or the like. The applied mixture of the sensor carriers 18 is typically a suspension.

The dimensions of the cavities 16 on the one hand, i.e., the side lengths and/or diameters of the holes of the shadow mask 12 and the size and/or diameter of the sensor carriers 18 on the other hand are of such dimensions in relation to one another that there is room for at most one sensor carrier 18 in each cavity 16 (FIG. 1C). Even if a second sensor carrier layer is arranged above a sensor carrier 18 in a cavity, then it is removed in a subsequent washing step. This ensures that the sensor carriers 18 are present on the base carrier 10 without any direct contact with one another and with a minimum spacing which corresponds to the thickness of the webs 14 (web width) and with an average center-center spacing which corresponds to the center-center distance d of the cavities 16. Immobilization of the sensor carriers 18 on the base carrier 10 is preferably provided, but it may also take place spontaneously here. The shadow mask 12 may remain on the base carrier 10, especially when the following measurement methods are not influenced in a negative manner by them. In this case, the result shown in FIG. 1C represents the finished device 100. Alternatively, the shadow mask may also be removed so that the finished device 100 is shown by FIG. 1D.

An alternative production variant is diagrammed schematically in FIG. 2, where corresponding elements are labeled with the same reference numerals as in FIG. 1. FIG. 2A here shows a base carrier 10 which corresponds to that shown in FIG. 1 but has a somewhat greater thickness. In the next step, the surface of the base carrier 10 is structured so that cavities 16 are formed in a two-dimensional grid-like arrangement bordered at the sides by webs 14 of the base carrier 10 that remain (FIG. 2B). The structuring may be accomplished, for example, by applying a mask and a braiding material from the exposed areas. Mechanical material erosion methods such as sandblasting or the like, particle bombardment or electron bombardment or lithographic etching methods or mechanical embossing may be considered for this purpose. The result is a surface-structured base carrier 10 which forms the cavities 16 in one piece.

The distribution, arrangement and optional immobilization of the sensor carriers 18 in the cavities 16 corresponds to the procedure illustrated in FIG. 1. The finished result is shown in FIG. 2C.

Various stages in detection of analytes using an inventive device according to FIG. 1 are shown schematically in FIG. 3. FIG. 3A shows three cavities 16 formed by the shadow mask 12 and the base carrier 10 in a sectional view. The left cavity has a sensor carrier 18₁ of a first population immobilized in it; the center cavity has a sensor carrier 18₂ of a second population immobilized in it and the right cavity has a sensor carrier 18₃ of a third population immobilized in it. Each of these sensor carriers 18 has a core 20, which serves [sic] one or more fluorescence markers, magnetite particles and/or other population-specific coding of a sensor carrier population 18₁, 18₂, 18₃, for example. The core 20 of each sensor carrier 18 is sheathed a coating 22, in particular comprising a polymeric material. The polymer coating 22 is furnished, for example, with a functional group to which a sensor molecule 24 is bound or conjugated. For each sensor carrier population 18₁, 18₂, 18₃, a different sensor molecule 24₁, 24₂, 24₃ is provided, interacting specifically with an analyte. The first sensor molecule 24₁ is specifically anti-IL1 antibody which reacts specifically with human IL1 antigen; the second sensor molecule 24₂ is anti-IL2 antibody, which reacts specifically with human IL2 antigen; and the third sensor molecule 24₃ is anti-IL3 antibody, which reacts specifically with human IL3 antigen. Immobilization of the sensor carriers 18 on the base carrier 10 is implemented here via the sensor molecules 24.

Then according to FIG. 3B human patient serum containing IL1 as the first analyte 26₁ and IL3 as the second analyte 26₃ [sic] (but not IL2) is added so that it comes in contact with the sensor carriers 18. There is a specific interaction between the corresponding sensor molecules 24₁ of the first sensor carrier population 18₁ with the analyte 26₁ and between sensor molecules 24₃ of the third sensor carrier population 18₃ with the analyte 26₃, thus resulting in non-covalent bonding.

In the next step according to FIG. 3C (after corresponding washing steps to remove non-bound components of the sample) a detection antibody 28 which may have a fluorescence marker is added. The detection antibodies 28 in turn react specifically with the bound analytes (IL1 26₁ and IL3 26₃) and bind to them non-covalently.

Detection of the bound analytes (IL1 26₁ and IL3 26₃) may then be performed with a fluorescence spectroscope on the basis of the fluorescence of the detection antibody 28, such that an assignment is made based on the fluorescence of the sensor carrier 18 and/or its core 20.

The description will be illustrated below on the basis of an exemplary embodiment, the procedures of which were already explained in conjunction with FIG. 3.

### EXAMPLE

### Detection of Various Human Interleukins

Carboxy-modified polymethacrylate particles with a diameter of 8 μm and with the following fluorescence properties were produced with the addition of different amounts of fluorescent dyes to the reaction mixture:

Microparticle population A:
Fluorescence 1: aminocoumarin
Fluorescence 2: 100% rhodamine
Microparticle population B:
Fluorescence 1: aminocoumarin
Fluorescence 2: 50% rhodamine
Microparticle population C:
Fluorescence 1: aminocoumarin
Fluorescence 2: 0% rhodamine

By carbodiimide coupling, antibodies to IL1 were coupled to the microparticle population A, antibodies to IL2 were coupled to microparticle population B and antibodies to IL3 were coupled to microparticle population C. To do so:
1. 10 mg 1-ethyl-3-(3-dimethylaminopropyl)carbodiimide (EDC) was dissolved in 1 mL distilled water and mixed with 1 mL bead suspension (25 mg beads) and incubated for 10 minutes at room temperature;
2. the beads were washed three times with 5 mL MES buffer, (pH 5.0);
3. 500 μg antibody protein was dissolved in 1 mL 0.1 M MES buffer (pH 5.0) and incubated for 4 hours at room temperature with the activated beads while shaking;
4. the beads were washed three times in MES buffer and then incubated for 2 hours at room temperature while shaking in MES buffer+0.2 M glycine;
5. the beads were washed three times in PBS and placed in 1 mL PBS and aliquoted into 50 μL aliquots which were frozen at −20° C. until further use.

To immobilize the prepared microparticle populations on the surface of the microtiter plate (96-well format, polystyrene black, transparent flat bottom):
1. a mesh aperture, gold, hole width 50×50 μm, web width 50 μm, diameter 3 mm is placed in the cavity of a microtest plate and secured there flatly by a spring ring;
2. one aliquot of the particle suspensions of each of the particle suspensions of the various microparticle populations is thawed and mixed and diluted by pipetting 2 μL of each suspension into distilled water, so that a particle density of 100 microparticles of each population per 1 μL water is achieved;
3. 1 μL of the mixture is pipetted into the center of the cavities of the microtest plate (16-well module on microscope slides) and overlayered with 10 μL PBS;
4. the microparticles of the three populations used are immobilized by incubating overnight at 4° C. while shaking.

Then the cavities are rinsed three times with PBS+0.1% Tween 20 (PBS-T). Human sera are then pipetted into the prepared cavities of the microtest plate in a dilution of 1:100 in PBS-T and incubated for 1 hour at room temperature.

Then the cavities are rinsed three times with PBS-Tween and incubated for 2 hours at room temperature with a mixture of anti-IL1, anti-IL2 and anti-IL3 phycoerythrin conjugate, which was diluted 1:100 in PBS-Tween. After rinsing three times with PBS-T, the fluorescence is analyzed with an automated fluorescence microscope IX81 (Olympus). The immobilized microparticles are photographed in succession with an s/w CCD camera using optical filter pairs for the following emission and absorption wavelengths: 390 nm/441 nm, 480 nm/520 nm and 480 nm/578 nm.

The analysis was performed by finding the ratio of the fluorescence intensities of the particle fluorescences relative to one another to identify microparticles of the respective population. Then the reporter fluorescences were detected, with the reporter fluorescence intensity being proportional to the analyte concentration.

After successful fluorescence spectroscopic measurement, the microscope slide was separated from the cavities of the microtiter module and the PBS-T was replaced by caffeic acid and dried. The microscope slides were then automatically analyzed with a MALDI mass spectrometer. The mass peaks of the fluorescent dyes yield the particle coding and the mass peaks of the interleukins provide information about samples of interleukin isoforms, e.g., with varying glycosylation.

### LIST OF REFERENCE NUMERALS

100 device for detecting analytes
10 basic carrier
12 perforated mass
14 web
16 cavity/well
18 sensor carrier
18₁ first sensor carrier population
18₂ second sensor carrier population
18₃ third sensor carrier population
20 core/coding
22 polymer coating
24 sensor molecule
24₁ anti-IL1 antibody (sensor molecule)
24₂ anti-IL2 antibody (sensor molecule)
24₃ anti-IL3 antibody (sensor molecule)
26 analyte
26₁ IL1 (analyte)
26₃ IL3 (analyte)
28 detection antibody with fluorescence marker
d center-center distance

1. A device for detecting analyte in a sample comprising
a base carrier,
a plurality of sensor carriers arranged on the base carrier, each being assignable to at least two different sensor carrier populations,
wherein the sensor carrier populations are defined at least by different sensor molecules assigned to the sensor carrier, each having at least one measurable specificity for an analyte or an analyte group, so that the population of the sensor carriers represents a coding that allows an assignment of sensor molecules or analyte,
characterized in that
the sensor carriers are situated on the base carrier with a predetermined average spacing from one another without contact with one another and with a random distribution with regard to the population.

2. The device according to claim 1, wherein the sensor carriers are arranged on the base carrier in a two-dimensional grid.

3. The device according to claim 1, wherein a surface of the base carrier is structured and the sensor carriers are arranged in cavities in the structure.

4. The device according to claim 1, wherein a surface of the base carrier is flat.

5. The device according to claim 1, wherein the predetermined average spacing of the sensor carriers is 1 to 1,000 μm.

6. The device according to claim 1, wherein the population of the sensor carriers is also defined by at least one additional chemical or physical property of the sensor carrier, comprising optical properties including infrared or UV-VIS spectral properties; electric properties including conductivity or resistance; molecular weight; chemical reactivity; hydrophobicity; polarity; magnetic properties; NMR spectral properties; size; shape or material composition.

7. The device according to claim 6, wherein the population of the sensor carriers is defined by different dyes including fluorescent dyes, ions, doping of different molecular weights including different peptides.

8. The device according to claim 1, wherein the basic structure is planar, macrostructured, microstructured or nanostructured, porous or nonporous, optically transparent or nontransparent, conductive or nonconductive, metallic, functionalized or not functionalized or has several of these properties in combination.

9. The device according to claim 1, wherein the base carrier has defined surface areas with different chemical or physical properties.

10. The device according to claim 1, wherein the base carrier comprises at least one material including glass, mica, metals, semiconductor metals, organic or inorganic polymers or a combination of these.

11. The device according to claim 1, wherein the base carrier is in the form of microtest plates, glass plates or mica plates, semiconductor wafers, flexible membranes, braids or fibrils.

12. The device according to claim 1, wherein the sensor carriers are in the form of particles, including macroparticles, microparticles or nanoparticles or spherical or nonspherical compositions including hydrogels.

13. The device according to claim 1, wherein the sensor carriers have a polymeric single layer or multilayer material comprising polystyrene, polymethacrylates, polypropylene, polyethylene, copolymers, silica or mixtures or composites thereof.

14. The device according to claim 13, wherein the polymer material surrounds or includes at least one additional material, including magnetic particles or fluorescent dyes, which serves to code for the population.

15. The device according to claim 13, wherein the polymer material has a surface functionality comprising chemically functional groups, including carboxyl groups, amino groups, aldehyde groups or epoxy groups or oligonucleotides, aptamers, peptides, lectins, antibodies, antigens, carbohydrates or small organic compounds including biotin or avidin.

16. The device according to claim 1, wherein the sensor molecules are covalently or non-covalently bonded to an external or internal surface of the sensor carriers.

17. The device according to claim 1, wherein the sensor molecules are selected from the group consisting of at least haptenes, antigens, proteins, peptides, amino acids, antibodies, small organic molecules, nucleic acids, carbohydrates, lipids or parts or mixtures of these molecules.

18. The device according to claim 1, wherein the analytes are selected from the group consisting of at least haptenes, antigens, proteins, peptides, amino acids, antibodies, small organic molecules, nucleic acids, carbohydrates, lipids or parts or mixtures of these molecules.

19. A method for producing a device, comprising
applying at least one shadow mask with a defined hole grid to a base carrier or creating a physical structuring or chemical modification of the base carrier, so that cavities or chemical binding areas are formed with a predetermined distance from the base carrier, and
assigning a mixture of a plurality of sensor carriers, to which at least two different populations on the base carrier so that the sensor carriers are arranged in the cavities or on the binding areas, whereby a dimension of the cavities or the binding areas and the sensor carriers relative to one another is such that there is room for at most one sensor carrier in each cavity and in each binding area.

20. The method according to claim 19, wherein the sensor carriers are immobilized on the base carrier.

21. The method according to claim 19, wherein the shadow mask remains permanently on the base carrier or is removed after application and immobilization of the sensor carriers.

22. A method for detecting at least one analyte in a sample, bringing a device according to claim 1 in contact with the sample containing at least one analyte, wherein the at least one analyte interacts with corresponding sensor molecules of the sensor carrier, characterized in that at least one property of the sensor carrier or of the analyte is detected simultaneously or in succession with resolution.

23. The method according to claim 22, wherein at least one property of the sensor carrier or of the analyte is determined by fluorescent spectroscopy, infrared spectroscopy, UV-VIS absorption spectroscopy, ellipsometry, mass spectroscopy, atomic force microscopy, scanning near-field microscopy, transmission electron microscopy, scanning electron microscopy or by simultaneous or sequential combinations of these methods.

24. A kit for detecting at least one analyte in a sample comprising a device according to claim 1 including base carriers, sensor carriers or sensor molecules and additional reagents.
